(19) United States
(12) Patent Application Publication
(10) Pub. No.: US 2025/0226427 A1
(43) Pub. Date: Jul. 10, 2025

(54) FUEL CELL BONDING JIG AND FUEL CELL BONDING METHOD

(71) Applicant: HONDA MOTOR CO., LTD., Tokyo (JP)

(72) Inventors: Takumi YAMAHATA, Saitama (JP); Yusuke WADA, Saitama (JP); Taichi KITAGAWA, Saitama (JP)

(21) Appl. No.: 18/976,362

(22) Filed: Dec. 11, 2024

(30) Foreign Application Priority Data
Jan. 9, 2024 (JP) 2024-001534

(51) Int. Cl. H01M 8/0286

(52) U.S. Cl. CPC H01M 8/0286

(57) ABSTRACT

A fuel cell bonding jig includes an upper jig and a lower jig. The fuel cell bonding jig is configured to be able to be set to a first state that corresponds to a state in which a first film is arranged on a lower surface of the upper jig, a second film is arranged on an upper surface of the lower jig, and an adhesive is applied to the film. A second state in which the first film and the second film face each other across an interval in a vertical direction is entered when the upper jig is attached onto the lower jig while the fuel cell bonding jig is in the first state. The fuel cell bonding jig is configured to be able to, from the second state, press the first film onto the second film.

This application is based on and claims the benefit of priority from Japanese Patent Application No. 2024-001534, filed on 9 Jan. 2024, the content of which is incorporated herein by reference.

### BACKGROUND OF THE INVENTION

### Field of the Invention

The present invention pertains to a jig and a method that are for bonding members of a fuel cell to one another.

### Related Art

There are fuel cells that include, in order from one side thereof, an anode-side gas diffusion layer, an intermediate layer, and a cathode-side gas diffusion layer. Such a fuel cell generates electricity when a fuel gas which is a gas containing hydrogen is supplied to the anode-side gas diffusion layer and an oxidizing gas which is a gas containing oxygen is supplied to the cathode-side gas diffusion layer.

Patent Document 1: Japanese Unexamined Patent Application, Publication No. 2023-161181

### SUMMARY OF THE INVENTION

In order to increase the durability of an intermediate layer in a fuel cell, the inventors are currently developing a structure that uses two films to protect edges of an electrolyte membrane from both sides. These two films configure a subgasket.

However, the inventors also paid attention to the presence of problems, which are described below, in such a configuration. Therefore, accurately bonding, as much as possible, these two films at correct relative positions is desirable. This is because, when bonding at relative positions that have deviated from correct relative positions is performed, there is a risk that warping of the subgasket formed from these two films will occur.

However, when bonding these two films, there are cases where these two films are bonded at relative positions that deviate from correct relative positions due to unintended contact between the films.

As a corresponding countermeasure, when bonding two films, consideration has been given to a method of temporarily interposing a PTFE sheet between the two films. Specifically, this method positions the two films, by the same positioning pins, on both sides of the PTFE sheet. An adhesive-side surface of a film is in contact with the PTFE sheet. Subsequently, the two films are caused to come into contact with each other while pulling out the PTFE sheet, whereby the two films are bonded by the adhesive.

This countermeasure can use the PTFE sheet to avoid unintended contact between the films. However, when pulling out the PTFE sheet, there is a risk that a film follows the PTFE sheet and deforms. Therefore, there is a risk that the two films will be bonded at relative positions that deviate from correct relative positions.

Note that, although a problem is described above by giving an example of a case of using two films to protect edges of an electrolyte membrane from both sides, a similar problem can occur even in a case where an intermediate layer in a fuel cell includes two films in an aspect other than that described above.

The present invention is made in light of the circumstances described above, and an object of the present invention is to, in a manufacturing stage for a fuel cell, facilitate accurately bonding, at correct relative positions, two films in an intermediate layer.

The inventors attained the present invention by finding that the object described above could be achieved if a prescribed jig were used. The present invention is the fuel cell bonding jig according to the following (1) through (9), and the fuel cell bonding method according to the following (10) through (12).
(1) A fuel cell bonding jig for bonding a first film to a second film in a manufacturing stage for a fuel cell provided with an intermediate layer that includes the first film and the second film, the fuel cell bonding jig including:
   an upper jig configured to allow the first film to be arranged on a lower surface of the upper jig; and a lower jig configured to allow the second film to be arranged on an upper surface of the lower jig,
   the fuel cell bonding jig being configured to be able to be set to a first state that corresponds to a state in which the first film is arranged on the lower surface of the upper jig, the second film is arranged on the upper surface of the lower jig, and an adhesive is applied to at least one of a lower surface of the first film or an upper surface of the second film,
   the fuel cell bonding jig is configured to be able to be set to a second state in which the first film and the second film face each other across an interval in a vertical direction when the upper jig is attached onto the lower jig while the fuel cell bonding jig is in the first state, and
   the fuel cell bonding jig being configured to be able to, from the second state, press the first film onto the second film.

By virtue of the present configuration, it is possible to cause the first film and the second film to face each other across an interval in the vertical direction, whereby unintended bonding of these two films is avoided. From this state, the first film is pressed onto the second film, whereby it is possible to bond the two films. Therefore, accurately bonding the two films at correct relative positions is facilitated.

Moreover, there is no need to arrange a previously-described PTFE sheet between the first film and the second film. Accordingly, there is no concern such as the two films bonding at relative positions that deviate from correct relative positions due to the first film or the second film following the PTFE sheet when pulling out the PTFE sheet.

By virtue of the present configuration as above, accurately bonding, at correct relative positions, two films in an intermediate layer in a manufacturing stage for a fuel cell is facilitated.
(2) The fuel cell bonding jig according to (1) above, including a collar for adjusting a clearance between the upper jig and the lower jig, the collar being replaceable.

By virtue of this configuration, replacing the collar to thereby cause the first film and the second film to face each other in the vertical direction across an appropriate interval is facilitated. Therefore, more accurately bonding the two films at correct relative positions is facilitated.
(3) The fuel cell bonding jig according to (1) or (2) above, including a presser,
   a jig window through which the presser can be inserted being formed in the upper jig, and
   the fuel cell bonding jig being configured to be able to, from the second state, insert the presser into the jig window and press a prescribed portion of the first film onto a prescribed portion of the second film.

By virtue of the present configuration, it is possible to insert the presser into the jig window and thereby press the prescribed portion of the first film onto the prescribed portion of the second film. As a result, more accurately bonding, at correct relative positions, the prescribed portion of the first film onto the prescribed portion of the second film is facilitated. Subsequently, based on the bonded prescribed portion of the first film and the prescribed portion of the second film, it is possible to bond portions other than the prescribed portions. Therefore, more accurately bonding the entirety of the first film and the second film at correct relative positions is facilitated.
(4) The fuel cell bonding jig according to any one of (1) through (3) above, the upper jig being provided with an upper vacuum gripper configured to be able to vacuum-grip the first film, and being configured to be able to use the vacuum-gripping by the upper vacuum gripper to arrange the first film on the lower surface of the upper jig.

By virtue of the present configuration, it is possible to use the vacuum-gripping by the upper vacuum gripper to arrange the first film on the lower surface of the upper jig, in opposition to gravity. Moreover, using this vacuum-gripping, extending the first film along the lower surface of the upper jig without deflection is facilitated. Therefore, more accurately bonding the two films at correct relative positions is facilitated.
(5) The fuel cell bonding jig according to (4) above, a positioner configured to position the first film being provided on the upper surface of the lower jig, and the upper vacuum gripper being configured to be able to vacuum-grip the first film positioned by the positioner, to the lower surface of the upper jig.

By virtue of the present configuration, it is possible to arrange the first film at a determined position on the lower surface of the upper jig by merely vacuum-gripping the first film to the lower surface of the upper jig after using the positioner to position the first film with respect to the lower jig. Therefore, more accurately bonding the two films at correct relative positions is facilitated.
(6) The fuel cell bonding jig according to any one of (1) through (5) above, a positioner configured to position the second film being provided on the upper surface of the lower jig.

By virtue of the present configuration, arranging the second film at a determined position on the upper surface of the lower jig is facilitated by the positioning pin. Therefore, more accurately bonding the two films at correct relative positions is facilitated.
(7) The fuel cell bonding jig according to any one of (1) through (6) above, the lower jig being provided with a lower vacuum gripper that is configured to be able to vacuum-grip the second film.

By virtue of the present configuration, extending the second film along the lower jig without deflection is facilitated by the vacuum-gripping by the lower vacuum gripper. Therefore, more accurately bonding the two films at correct relative positions is facilitated.
(8) The fuel cell bonding jig according to any one of (1) through (7) above, the lower jig being provided with a positioning shaft that protrudes upward, and the upper jig being positioned horizontally with respect to the lower jig by the positioning shaft.

By virtue of the present configuration, correctly aligning the upper jig with the lower jig is facilitated using the positioning shaft. As a result, more accurately bonding the two films at correct relative positions is facilitated.
(9) The fuel cell bonding jig according to any one of (1) through (8) above, each of the first film and the second film including a protective film for protecting edges of an electrolyte membrane, and one of the first film or the second film further including the electrolyte membrane.

By virtue of the present configuration, it is possible to protect edges of the electrolyte membrane using the protective film belonging to the first film and the protective film belonging to the second film.
(10) A fuel cell bonding method for bonding a first film to a second film in a manufacturing stage for a fuel cell provided with an intermediate layer that includes the first film and the second film, the fuel cell bonding method including:
   preparing a jig that is provided with an upper jig configured to allow the first film to be arranged on a lower surface of the upper jig, and a lower jig configured to allow the second film to be arranged on an upper surface of the lower jig; setting the jig to a first state that corresponds to a state in which the first film is arranged on the lower surface of the upper jig, the second film is arranged on the upper surface of the lower jig, and an adhesive is applied to at least one of a lower surface of the first film or an upper surface of the second film;
   setting the jig to a second state in which the first film and the second film face each other across an interval in a vertical direction, by attaching the upper jig onto the lower jig while the jig is in the first state; and
   from the second state, causing the first film to bond to the second film by pressing the first film onto the second film.

By virtue of the present method, accurately bonding two films at correct relative positions is facilitated, similarly to the case of the jig according to (1) above.
(11) The fuel cell bonding method according to (10) above, the jig being provided with a presser,
   a jig window through which the presser can be inserted being formed in the upper jig, and
   a first prescribed portion that corresponds to a prescribed portion of the first film being bonded by the adhesive to a second prescribed portion that corresponds to a prescribed portion of the second film by, from the second state, inserting the presser into the jig window and pressing the first prescribed portion onto the second prescribed portion.

By virtue of the present method, more accurately bonding two films at correct relative positions is facilitated, similarly to the case in (3) above.
(12) The fuel cell bonding method according to (11), a portion of the first film that is not the first prescribed portion being bonded by the adhesive to a portion of the second film that is not the second prescribed portion by removing a joined body of the first film and the second film from the jig, and then pressing the joined body by a roller.

By virtue of the present configuration, more accurately bonding, at correct relative positions, of the portion of the first film that is not the first prescribed portion to the portion of the second film that is not the second prescribed portion is facilitated by pressing the joined body by the roller.

By virtue of the jig according to (1) above and the method according to (10) above, accurately bonding two films at correct relative positions is facilitated. Furthermore, by virtue of the jig according to the above-described (2) through (9) that cite the above-described (1), and the method according to (11) and (12) that cite the above-described (10), respective additional effects are achieved.

### BRIEF DESCRIPTION OF THE DRAWINGS

FIG. 1 is a perspective view illustrating a fuel cell bonding jig according to a first embodiment;

FIG. 2 is an exploded cross-sectional view illustrating the fuel cell bonding jig;

FIG. 3 is a cross-sectional view illustrating a state in which a first film has been mounted on the upper surface of a lower jig;

FIG. 4 is a cross-sectional view illustrating a state in which an upper jig has been mounted onto the lower jig;

FIG. 5 is a cross-sectional view illustrating a state in which the first film is vacuum-gripped to the lower surface of the upper jig;

FIG. 6 is a cross-sectional view illustrating a state in which the upper jig has been removed from the lower jig;

FIG. 7 is a cross-sectional view illustrating a state in which a second film has been mounted onto the lower jig;

FIG. 8 is a cross-sectional view illustrating a state in which the upper jig has been mounted onto the lower jig;

FIG. 9 is a cross-sectional view illustrating a state in which a first prescribed portion is pressed onto a second prescribed portion by a presser;

FIG. 10 is a cross-sectional view illustrating a state in which a joined body is pressed by a roller;

FIG. 11 is a cross-sectional view illustrating an intermediate layer in a fuel cell; and

FIG. 12 is a cross-sectional view illustrating a state in which gas diffusion layers are attached to both sides of the intermediate layer.

### DETAILED DESCRIPTION OF THE INVENTION

With reference to the drawings, description is given below regarding embodiments of the present invention. However, the present invention is not limited whatsoever to the following embodiments, and can be worked after being changed, as appropriate, within a range that does not deviate from the spirit of the present invention.

### First Embodiment

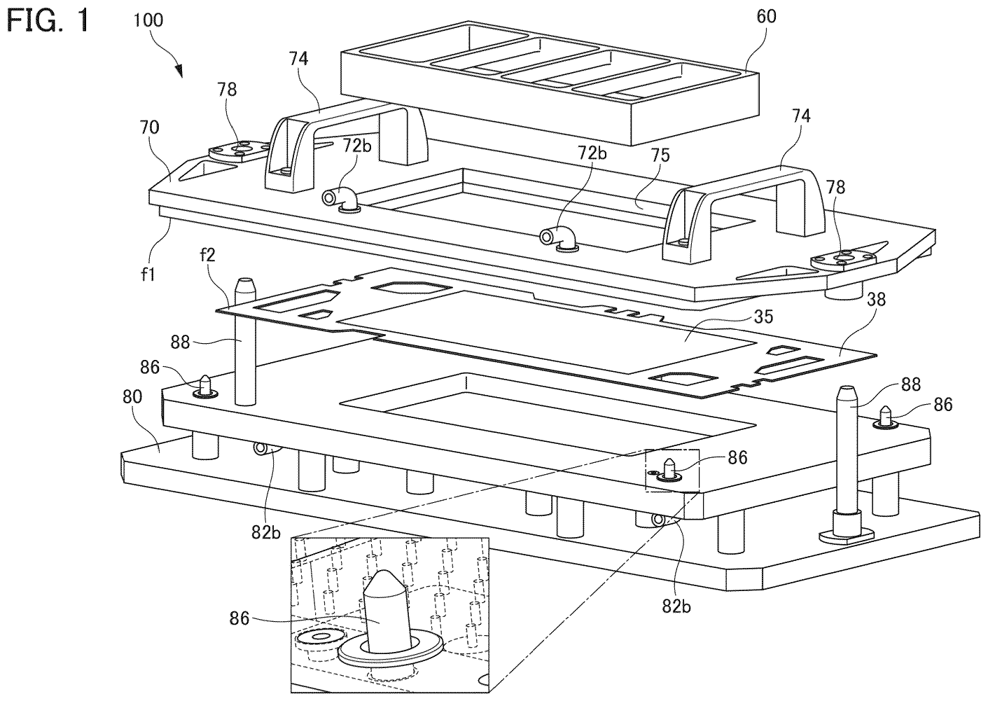

A fuel cell bonding jig 100 illustrated in FIG. 1 is for manufacturing a fuel cell 50 that is illustrated in FIG. 12. Note that the fuel cell bonding jig 100 may be simply interpreted as a “jig”.

As illustrated in FIG. 12, the fuel cell 50 is provided with, in order from one side, a first gas diffusion layer 20, an intermediate layer 30, and a second gas diffusion layer 40. The first gas diffusion layer 20 is an anode-side gas diffusion layer. The second gas diffusion layer 40 is a cathode-side gas diffusion layer. Note that the intermediate layer 30 may be interpreted as a “UEA” or a “unitized electrode assembly”.

The intermediate layer 30 includes, in order from one side, a first protective film 32, an electrolyte membrane 35, and a second protective film 38. The first protective film 32 is for protecting edges of the electrolyte membrane 35 from one side. The second protective film 38 is for protecting the edges of the electrolyte membrane 35 from the other side.

The first protective film 32 and the second protective film 38 are made of resin. These two protective films 32, 38 configure a subgasket. A film window 32w, which is for exposing a portion of the electrolyte membrane 35 apart from the edges thereof, on one side, is formed at the center of the first protective film 32. A film window 38w, which is for exposing a portion of the electrolyte membrane 35 other than the edges thereof, on the other side, is formed at the center of the second protective film 38.

In another perspective, the above-mentioned intermediate layer 30 includes a first film f1 and a second film f2, which are described next.

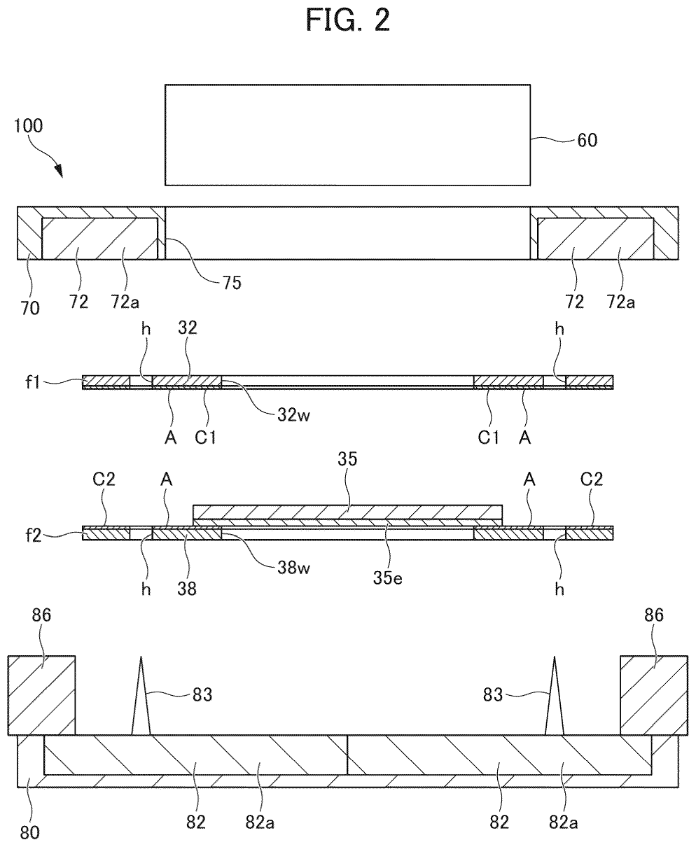

As illustrated in FIG. 2, the first film f1 includes the first protective film 32. The second film 12 includes the electrolyte membrane 35 and the second protective film 38. The electrolyte membrane 35 is attached to the second protective film 38 so as to block the film window 38w in the second protective film 38 from one side. Specifically, an adhesive A is used to affix edges of the electrolyte membrane 35 to a periphery of the film window 38w in the second protective film 38.

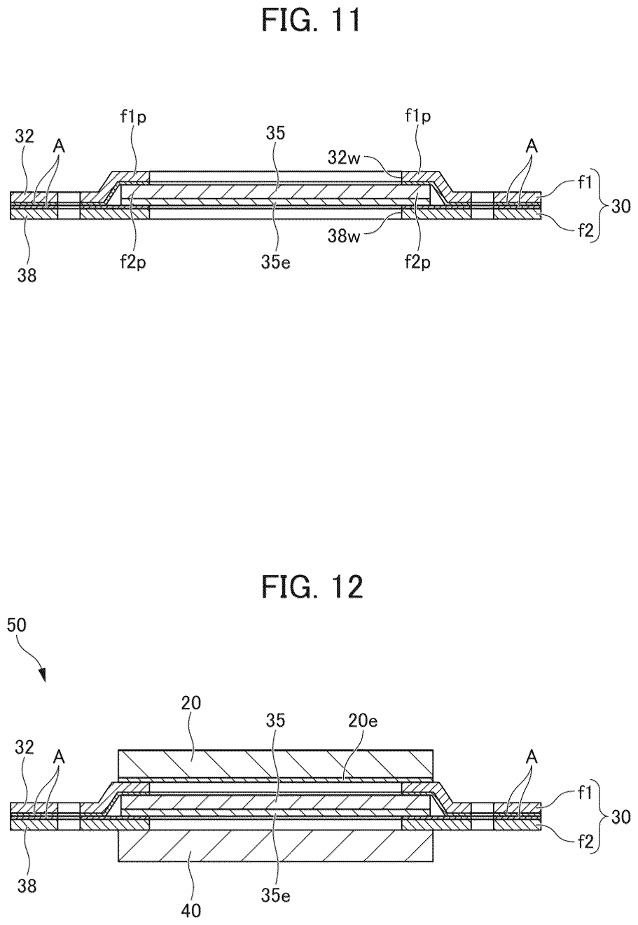

As illustrated in FIG. 11, the adhesive A is used to bond the first film f1 onto the second film f2, whereby the intermediate layer 30 is formed. At this point, the edges of the electrolyte membrane 35 are protected on both sides by the first protective film 32 and the second protective film 38.

As illustrated in FIG. 12, the first gas diffusion layer 20 is attached to the first film f1 from the one side, and the second gas diffusion layer 40 is attached to the second film f2 from the other side. Note that an anode electrode 20e is formed on the intermediate layer 30—side surface of the first gas diffusion layer 20. In addition, a cathode electrode 35e is provided on the second protective film 38—side surface of the electrolyte membrane 35.

Below, a gas that includes hydrogen is referred to as a “fuel gas”, and a gas that includes oxygen is referred to as an “oxidizing gas”. When the fuel cell 50 is used, the anode electrode 20e and the cathode electrode 35e are electrically connected via a circuit that includes a power-supply target. In this state, power is generated when the fuel gas is supplied to the first gas diffusion layer 20 and the oxidizing gas is supplied to the second gas diffusion layer 40.

The fuel cell bonding jig 100 illustrated in FIG. 1 is for bonding the first film f1 to the second film f2 in a manufacturing stage for the fuel cell 50 described above. This fuel cell bonding jig 100 is provided with an upper jig 70, a lower jig 80, and a presser 60.

The lower jig 80 is provided with positioning shafts 88 that protrude upward from the upper surface of the lower jig 80. Each positioning shaft 88 is inserted into an insertion hole 78 provided in the upper jig 70, whereby the upper jig 70 is horizontally positioned with respect to the lower jig 80.

As illustrated in FIG. 2, the lower jig 80 is also provided with lower vacuum grippers 82, positioning pins 83, and collars 86. Note that the positioning pins 83 may each be interpreted to as a “positioner”.

Each lower vacuum gripper 82 is provided with a porous body 82a and a suction system 82b that is illustrated in FIG. 1. As illustrated in FIG. 2, the porous body 82a is provided on the upper surface of the lower jig 80. When the lower vacuum grippers 82 are turned on, the suction systems 82b suction air that is in the porous bodies 82a. As a result, the second film f2 is vacuum-gripped to the upper surface of the lower jig 80.

The positioning pins 83 are for positioning the first film f1 and the second film f2 with respect to the lower jig 80. Specifically, insertion holes h are provided in the first film f1 and the second film f2. The positioning pins 83 are inserted into the insertion holes h, whereby the first film f1 and the second film f2 are positioned with respect to the lower jig 80. Note that the positioning pins 83 may each be interpreted as a “positioner”.

The collars 86 are members for adjusting the clearance between the upper jig 70 and the lower jig 80. The collars 86 are replaceably attached to the lower jig 80.

A jig window 75 is provided at the center of the upper jig 70, as illustrated in FIG. 1. As illustrated in FIG. 2, the jig window 75 is slightly larger than the film windows 32w, 38w. This jig window 75 is configured such that the presser 60 can be inserted therein. Handles 74 are respectively provided on both sides of the jig window 75 in the upper jig 70.

The upper jig 70 is provided with upper vacuum grippers 72, as illustrated in FIG. 2. Each upper vacuum gripper 72 is provided with a porous body 72a and a suction system 72b that is illustrated in FIG. 1. As illustrated in FIG. 2, the porous body 72a is provided on the upper surface of the upper jig 70. When the upper vacuum grippers 72 are turned on, the suction systems 72b suction air that is in the porous bodies 72a. As a result, the first film f1 is vacuum-gripped to the lower surface of the upper jig 70.

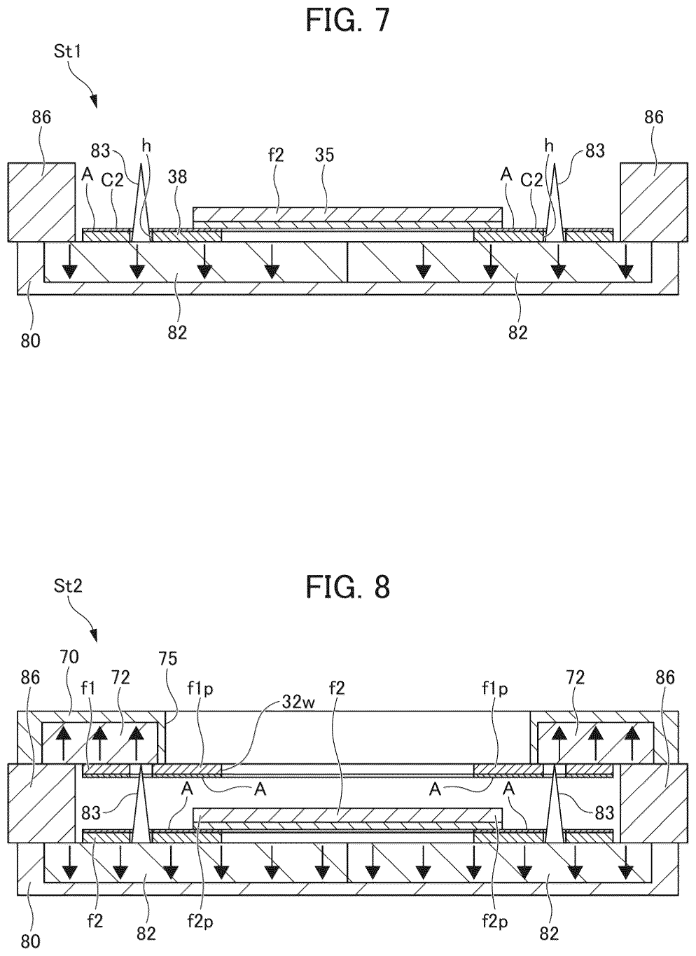

A state in which the first film f1 is arranged on the lower surface of the upper jig 70 as illustrated in FIG. 6, the second film f2 is arranged on the upper surface of the lower jig 80 as illustrated in FIG. 7, and the adhesive A is applied onto the lower surface of the first film f1 and the upper surface of the second film f2 is referred to as a “first state St1” below. However, the “lower surface” referred to here is the “lower surface” in a state where the upper jig 70 is attached to the lower jig 80. Accordingly, in this first state St1, the upper jig 70 may be temporarily placed by setting the lower surface to be upward. The fuel cell bonding jig 100 is configured to be able to be set in this first state St1.

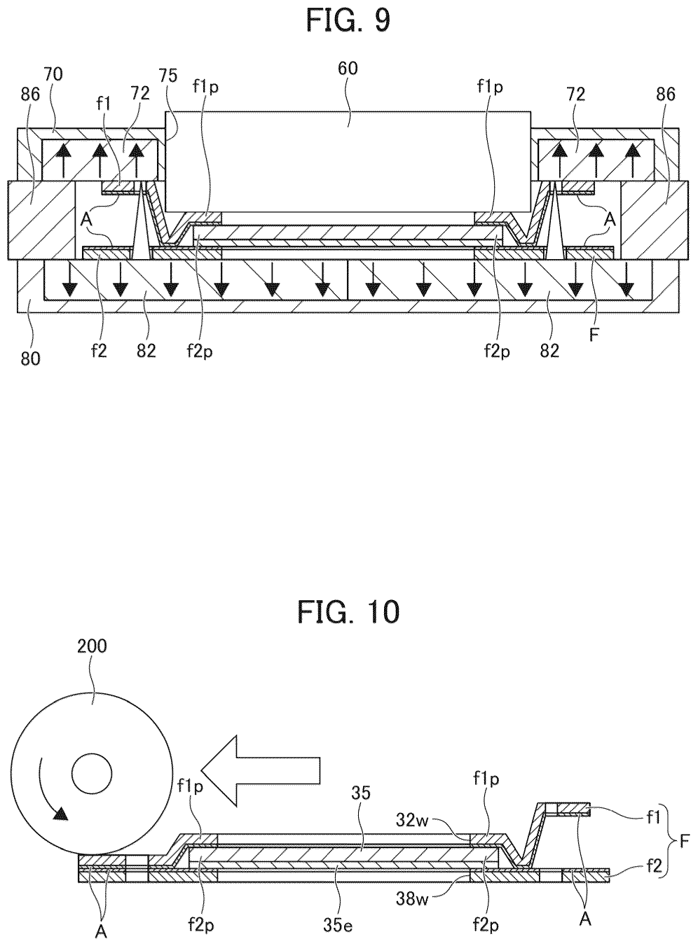

When, in the first state St1, the upper jig 70 is attached onto the lower jig 80 as illustrated in FIG. 8, the fuel cell bonding jig 100 enters a second state St2 in which the first film f1 and the second film f2 face each other across an interval in the vertical direction. The fuel cell bonding jig 100 is configured to be able to, from this second state St2, insert the presser 60 into the jig window 75 and thereby press the second film f2 onto the first film f1, as illustrated in FIG. 9.

Next, description is given regarding a fuel cell bonding method that is performed using the fuel cell bonding jig 100 described above.

Firstly, a worker prepares the fuel cell bonding jig 100 illustrated in FIG. 2 and also prepares the first film f1 and the second film f2. The adhesive A is applied to the lower surface of the first film f1. A first cover C1 is attached below the adhesive A. The adhesive A is applied to a portion on the upper surface of the second film f2 that faces the first film f1. A second cover C2 is attached onto this adhesive A.

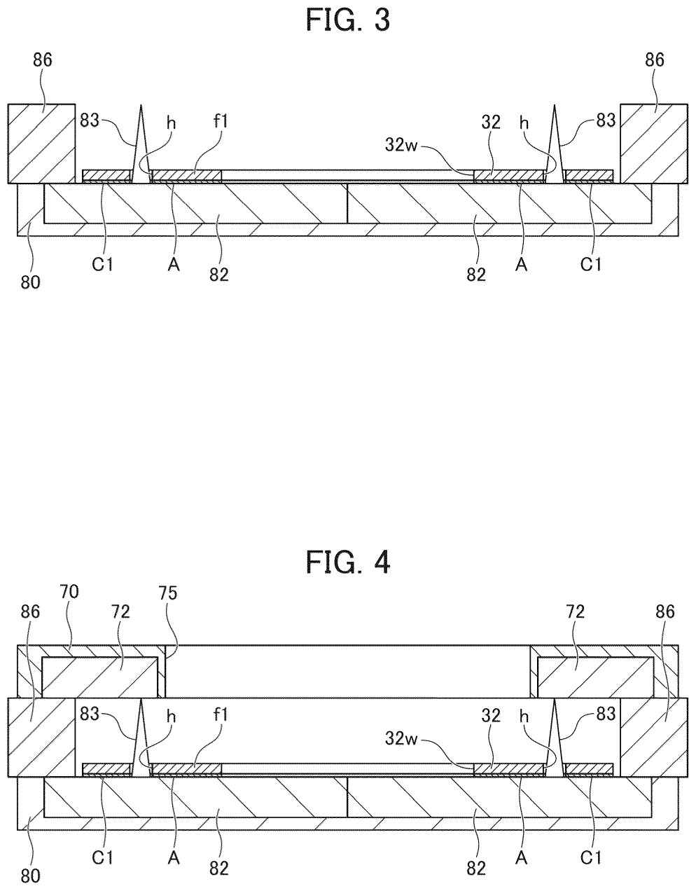

Next, the worker arranges the first film f1 on the upper surface of the lower jig 80 as illustrated in FIG. 3. At this point, the positioning pins 83 are caused to be inserted into the insertion holes h in the first film f1. As a result, the first film f1 is correctly positioned with respect to the lower jig 80. Note that, at this point, due to the presence of the first cover C1, the adhesive A on the lower surface of the first film f1 being affixed to the upper surface of the lower jig 80 does not occur.

Next, from this state, the worker mounts the upper jig 70 onto the lower jig 80, as illustrated in FIG. 4. At this point, the positioning shafts 88, which are on the lower jig 80 and are illustrated in FIG. 1, are caused to be inserted into the insertion holes 78 in the upper jig 70. As a result, the upper jig 70 is correctly positioned with respect to the lower jig 80, as illustrated in FIG. 4.

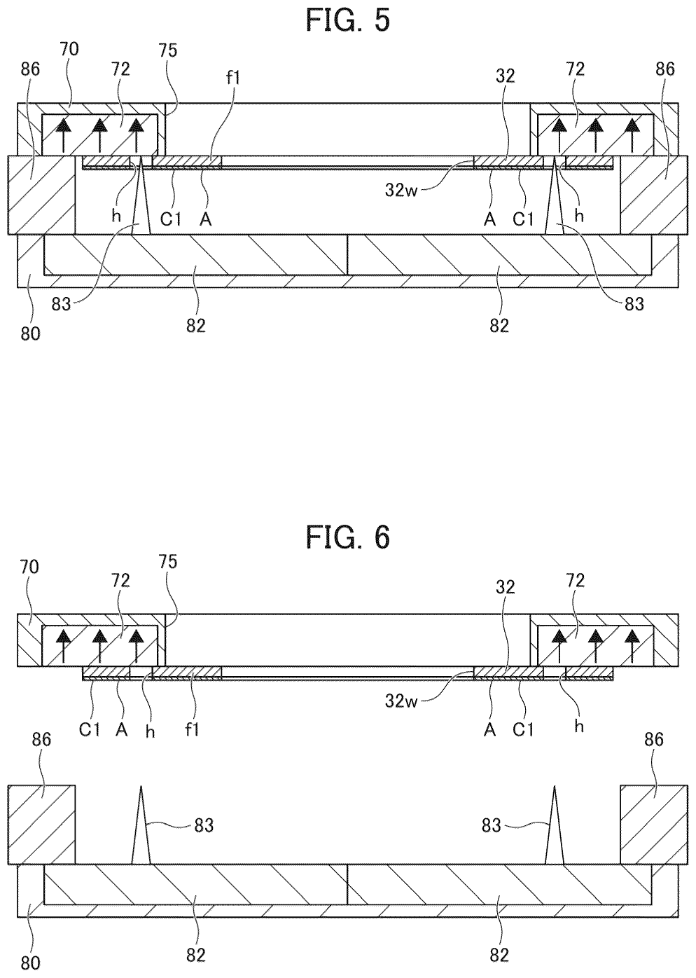

Next, from this state, the worker turns the upper vacuum grippers 72 on, as illustrated in FIG. 5. As a result, the first film f1, which was arranged on the upper surface of the lower jig 80, is vacuum-gripped to the lower surface of the upper jig 70 and thereby arranged on this lower surface. While this state is maintained, the worker removes the upper jig 70 from the lower jig 80, as illustrated in FIG. 6.

Next, from this state, the worker arranges the second film f2 on the upper surface of the lower jig 80 as illustrated in FIG. 7. At this point, the positioning pins 83 are caused to be inserted into the insertion holes h in the second film f2. As a result, the second film f2 is correctly positioned with respect to the lower jig 80. Next, the worker turns the lower vacuum grippers 82 on. As a result, the second film f2 is vacuum-gripped to the upper surface of the lower jig 80.

Next, from this state, the worker removes the first cover C1 that is illustrated in FIG. 6, and also removes the second cover C2 that is illustrated in FIG. 7. As a result, the previously-described first state St1 is entered. In other words, a state in which the first film f1 is arranged on the lower surface of the upper jig 70, the second film f2 is arranged on the upper surface of the lower jig 80, and the adhesive A is applied onto the lower surface of the first film f1 and the upper surface of the second film f2, is entered.

Next, from this state, the worker mounts the upper jig 70 onto the lower jig 80, as illustrated in FIG. 8. At this point, the positioning shafts 88, which are on the lower jig 80 and are illustrated in FIG. 1, are caused to be inserted into the insertion holes 78 in the upper jig 70. As a result, the upper jig 70 is correctly positioned with respect to the lower jig 80, as illustrated in FIG. 8. As a result, the previously-described second state St2 is entered. In other words, the first film f1 and the second film f2 face each other across an interval in the vertical direction.

Below, a prescribed portion of the first film f1 is referred to as a “first prescribed portion f1p”, and a prescribed portion of the second film f2 is referred to as a “second prescribed portion f2p”. Specifically, the first prescribed portion f1p is a portion of the first film f1 that is peripheral to the film window 32w, and the second prescribed portion f2p is a portion of the second film f2 that faces the first prescribed portion f1p.

Next, from the second state St2, the worker inserts the presser 60 into the jig window 75, as illustrated in FIG. 9. Using the presser 60, the first prescribed portion f1p is pressed onto the second prescribed portion f2p, and the first prescribed portion f1p is bonded to the second prescribed portion f2p by the adhesive A. As a result, a joined body F of the first film f1 and the second film f2 is formed.

Next, the worker turns off the upper vacuum grippers 72 and the lower vacuum grippers 82, and removes the upper jig 70 from the lower jig 80. Next, the worker removes the joined body F from the fuel cell bonding jig 100, as illustrated in FIG. 10. Subsequently, the worker uses a roller 200 to press the joined body F, whereby a portion of the first film f1 that is not the first prescribed portion f1p is bonded to a portion of the second film f2 that is not the second prescribed portion f2p, by the adhesive A. Specifically, a portion of the first film f1 that is outside the first prescribed portion f1p is bonded, by the adhesive A, to a portion of the second film f2 that is outside the second prescribed portion f2p.

As a result, the intermediate layer 30 illustrated in FIG. 11 is completed. The above is the fuel cell bonding method.

Subsequently, the first gas diffusion layer 20 is attached to the anode side of this intermediate layer 30 and the second gas diffusion layer 40 is attached to the cathode side of the intermediate layer 30, as illustrated in FIG. 12.

The configuration and effects of the present embodiment are summarized below.

As illustrated in FIG. 8, the first film f1 and the second film f2 are caused to face each other across an interval in the vertical direction, whereby it is possible to avoid unintentionally bonding these two films f1, f2. From this state, as illustrated in FIG. 9, the first film f1 is pressed onto the second film f2, whereby it is possible bond these two films f1, f2. Therefore, accurately bonding the two films f1, f2 at correct relative positions is facilitated. As a result, it is possible to suppress warping of a subgasket that is formed from the two protective films 32, 38.

As illustrated in FIG. 8, the fuel cell bonding jig 100 is provided in a manner that enables replacement of the collars 86, which are for adjusting the clearance between the upper jig 70 and the lower jig 80. Therefore, replacing the collars 86 to thereby cause the first film f1 and the second film f2 to face each other in the vertical direction across an appropriate interval is facilitated. Therefore, more accurately bonding these two films f1, f2 at correct relative positions is facilitated.

The jig window 75 is formed in the upper jig 70. The fuel cell bonding jig 100 is configured to be able to, from the second state St2 illustrated in FIG. 8, insert the presser 60 into the jig window 75 and thereby press the first prescribed portion f1p onto the second prescribed portion f2p, as illustrated in FIG. 9. By inserting the presser 60 from the jig window 75, accurately bonding the first prescribed portion f1p to the second prescribed portion f2p at correct relative positions is facilitated. Subsequently, based on the bonded first prescribed portion f1p and second prescribed portion f2p, portions other than the first prescribed portion f1p and the second prescribed portion f2p can be bonded to each other, as illustrated in FIG. 10. Therefore, more accurately bonding of the entirety of the first film f1 and the second film f2 at correct relative positions is facilitated.

As illustrated in FIG. 5, the upper jig 70 is provided with the upper vacuum grippers 72, which are configured to be able to vacuum-grip the first film f1. Accordingly, the upper jig 70 can use the vacuum-gripping by the upper vacuum grippers 72 to arrange the first film f1 on the lower surface of the upper jig 70, in opposition to gravity. Moreover, using this vacuum-gripping, extending the first film f1 along the lower surface of the upper jig 70 without deflection is facilitated. Therefore, accurately bonding the two films f1, f2 at correct relative positions is facilitated.

As illustrated in FIG. 3, the positioning pins 83 for positioning the first film f1 are provided on the lower jig 80. The upper jig 70 illustrated in FIG. 5 is configured to be able to vacuum-grip the first film f1, which is positioned on the upper surface of the lower jig 80 using the positioning pins 83. Therefore, arranging the first film f1 at a determined position on the lower surface of the upper jig 70 is facilitated. Therefore, more accurately bonding the two films f1, f2 at correct relative positions is facilitated.

As illustrated in FIG. 7, the positioning pins 83, which are able to position the second film f2, are provided on the lower jig 80. Using these positioning pins 83, arranging the second film f2 at a determined position on the upper surface of the lower jig 80 is facilitated. Therefore, more accurately bonding the two films f1, f2 at correct relative positions is facilitated.

As illustrated in FIG. 7, the lower jig 80 is provided with the lower vacuum grippers 82 which are configured to be able to vacuum-grip the second film f2. Using the vacuum-gripping by the lower vacuum grippers 82, extending the second film f2 along the lower jig 80 without deflection is facilitated. Therefore, more accurately bonding the two films f1, f2 at correct relative positions is facilitated.

As illustrated in FIG. 1, the lower jig 80 is provided with the positioning shafts 88, which protrude upward. Using the positioning shafts 88, the upper jig 70 is positioned horizontally with respect to the lower jig 80. Accordingly, correctly aligning the upper jig 70 with the lower jig 80 is facilitated by the positioning shafts 88. Therefore, more accurately bonding the two films f1, f2 at correct relative positions is facilitated.

As illustrated in FIG. 11, the first film f1 and the second film f2 respectively include the protective films 32, 38 for protecting the edges of the electrolyte membrane 35. Accordingly, it is possible to protect the edges of the electrolyte membrane 35 by these protective films 32, 38.

The joined body F of the first film f1 and the second film f2 is removed from the fuel cell bonding jig 100 illustrated in FIG. 9. Subsequently, as illustrated in FIG. 10, the joined body F is pressed by the roller 200, whereby a portion of the first film f1 that is not the first prescribed portion f1p is bonded to a portion of the second film f2 that is not the second prescribed portion f2p, by the adhesive A. As a result, more accurately bonding, at correct relative positions, the portion of the first film f1 that is not the first prescribed portion f1p to the portion of the second film f2 that is not the second prescribed portion f2p is facilitated. In addition, pressing by the roller 200 in this manner enables further suppression of warping by the subgasket formed from the two protective films 32, 38 illustrated in FIG. 11.

### Other Embodiments

The embodiments described above can be modified as follows, for example.

It maybe that the first film f1 illustrated in FIG. 11 includes the first protective film 32 and the electrolyte membrane 35, and the second film f2 includes the second protective film 38. It may be that the first film f1 illustrated in FIG. 2 is mounted on the upper surface of the lower jig 80, and the second film f2 is mounted on the lower surface of the upper jig 70.

It may be that, in the first state St1 illustrated in FIG. 6 and FIG. 7 and the second state St2 illustrated in FIG. 8, the adhesive A is applied to only one of the lower surface of the upper jig 70 or the upper surface of the lower jig 80. The positioning pins 83 may be positioners that are not pins, such as grooves or locking parts.

It may be that a fastener for securing the first film f1 to the lower surface of the upper jig 70 is provided in place of the upper vacuum grippers 72, such as in a case where it is possible to sufficiently extend the first film f1 along the lower surface of the upper jig 70, even if the upper vacuum grippers 72 illustrated in FIG. 5 are not present. It may be that, in place of the presser 60 illustrated in FIG. 9, a worker pressers the first film f1 onto the second film f2, by using their hands or the like.

It may be that the jig window 75 is not formed in the upper jig 70 illustrated in FIG. 8 and, instead, the upper jig 70 is configured to be able to further descend from the second state St2 illustrated in FIG. 8. In other words, in this case, the upper jig 70 is caused to further descend from the second state St2, whereby it is possible to cause the first film f1 to bond to the second film f2.

### EXPLANATION OF REFERENCE NUMERALS

30 Intermediate layer
32 First protective film (protective film)
35 Electrolyte membrane
38 Second protective film (protective film)
50 Fuel cell
60 Presser
70 Upper jig
72 Upper vacuum gripper
80 Lower jig
82 Lower vacuum gripper
83 Positioning pin (positioner)
86 Collar
88 Positioning shaft
100 Fuel cell bonding jig
200 Roller
A Adhesive
f1 First film
f1p First prescribed portion
f2 Second film
f2p Second prescribed portion
St1 First state
St2 Second state

What is claimed is:

1. A fuel cell bonding jig for bonding a first film to a second film in a manufacturing stage for a fuel cell provided with an intermediate layer that includes the first film and the second film, the fuel cell bonding jig comprising:
an upper jig configured to allow the first film to be arranged on a lower surface of the upper jig; and a lower jig configured to allow the second film to be arranged on an upper surface of the lower jig,
wherein the fuel cell bonding jig is configured to be able to be set to a first state that corresponds to a state in which the first film is arranged on the lower surface of the upper jig, the second film is arranged on the upper surface of the lower jig, and an adhesive is applied to at least one of a lower surface of the first film or an upper surface of the second film,
the fuel cell bonding jig is configured to be able to be set to a second state in which the first film and the second film face each other across an interval in a vertical direction when the upper jig is attached onto the lower jig while the fuel cell bonding jig is in the first state, and
the fuel cell bonding jig is configured to be able to, from the second state, press the first film onto the second film.

2. The fuel cell bonding jig according to claim 1, further comprising:
a collar for adjusting a clearance between the upper jig and the lower jig, the collar being replaceable.

3. The fuel cell bonding jig according to claim 1, further comprising:
a presser,
wherein a jig window through which the presser can be inserted is formed in the upper jig, and
the fuel cell bonding jig is configured to allow, from the second state, the presser to be inserted into the jig window and press a prescribed portion of the first film onto a prescribed portion of the second film.

4. The fuel cell bonding jig according to claim 1, wherein
the upper jig is provided with an upper vacuum gripper configured to be able to vacuum-grip the first film, and is configured to be able to use the vacuum-gripping by the upper vacuum gripper to arrange the first film on the lower surface of the upper jig.

5. The fuel cell bonding jig according to claim 4, wherein
a positioner configured to position the first film is provided on the upper surface of the lower jig, and
the upper vacuum gripper is configured to be able to vacuum-grip the first film positioned by the positioner, on the lower surface of the upper jig.

6. The fuel cell bonding jig according to claim 1, wherein
a positioner configured to position the second film is provided on the upper surface of the lower jig.

7. The fuel cell bonding jig according to claim 1, wherein
the lower jig is provided with a lower vacuum gripper configured to be able to vacuum-grip the second film.

8. The fuel cell bonding jig according to claim 1, wherein
the lower jig is provided with a positioning shaft that protrudes upward, and
the upper jig is positioned horizontally with respect to the lower jig by the positioning shaft.

9. The fuel cell bonding jig according to claim 1, wherein
each of the first film and the second film includes a protective film for protecting edges of an electrolyte membrane, and
one of the first film or the second film further includes the electrolyte membrane.

10. A fuel cell bonding method for bonding a first film to a second film in a manufacturing stage for a fuel cell provided with an intermediate layer that includes the first film and the second film, the fuel cell bonding method comprising:
preparing a jig that is provided with an upper jig configured to allow the first film to be arranged on a lower surface of the upper jig, and a lower jig configured to allow the second film to be arranged on an upper surface of the lower jig;
setting the jig to a first state that corresponds to a state in which the first film is arranged on the lower surface of the upper jig, the second film is arranged on the upper surface of the lower jig, and an adhesive is applied to at least one of a lower surface of the first film or an upper surface of the second film;
setting the jig to a second state in which the first film and the second film face each other across an interval in a vertical direction, by attaching the upper jig onto the lower jig while the jig is in the first state; and
from the second state, causing the first film to bond to the second film by pressing the first film onto the second film.

11. The fuel cell bonding method according to claim 10, wherein
the jig is provided with a presser,
a jig window through which the presser can be inserted is formed in the upper jig, and
a first prescribed portion that corresponds to a prescribed portion of the first film is bonded by the adhesive to a second prescribed portion that corresponds to a prescribed portion of the second film by, from the second state, inserting the presser into the jig window and pressing the first prescribed portion onto the second prescribed portion.

12. The fuel cell bonding method according to claim 11, wherein
a portion of the first film that is not the first prescribed portion is bonded by the adhesive to a portion of the second film that is not the second prescribed portion by removing a joined body of the first film and the second film from the jig, and then pressing the joined body by a roller.
